(19) United States
(12) Patent Application Publication
(10) Pub. No.: US 2004/0262184 A1
(43) Pub. Date: Dec. 30, 2004

(54) Display case for collectable model cars

(76) Inventor: William C. Livesay, Eugene, OR (US)

Correspondence Address: Robert E. Howard, P.O. Box 10345, Eugene, OR, 97440, US

(21) Appl. No.: 10/865,142

(22) Filed: Jun. 9, 2004

Related U.S. Application Data
(60) Provisional application No. 60/477,645, filed on Jun. 10, 2003.

(51) Int. Cl. B65D 73/00; G02B 27/22

(52) U.S. Cl. 206/471; 206/461

(57) ABSTRACT

A case for displaying model cars contained in a package, the package including a backing and a transparent box attached to the backing for housing a model car. The case includes right and left rails with opposing right and left slots therein. A stop stop ledge extends along the bottom edge of the case. The slots are adapted to receive the side edges of the backings of a plurality of packages containing model cars to form a vertical array for display.

### CROSS-REFERENCE TO RELATED APPLICATIONS

This application claims the benefit of U.S. Provisional Application No. 60/477,645 filed Jun. 10, 2003.

### BACKGROUND OF THE INVENTION

The present invention relates to a display case for collectable model cars.

Collecting small model cars is a favorite pastime for many people, young and old. One large manufacturer of such model cars is Mattel, Inc. who sells a line of model cars under the registered trademark “Hot Wheels”. These cars come in packages that includes a cardboard backing with printed matter contained thereon, and a transparent plastic box attached to the lower portion of the cardboard backing which contains the model car. Although children tend to remove the car from its packaging in order to be able to play with it, serious collectors leave the car in its original packaging.

Where the collector has a large number of these model cars, displaying them becomes a problem.

### SUMMARY OF THE INVENTION

It is an object of the present invention to provide a display case for model cars for model cars contained in their original or replacement packaging.

The original or replacement package includes a backing and a transparent box attached to the backing for housing a model car.

The case includes substantially parallel right and left rails with opposing right and left slots therein. A stop stop ledge extends along the bottom edge of the case. The slots are adapted to receive the side edges of the backings of two or more packages to form a vertical display.

In one embodiment, the display case includes a plate member having inner and outer planar surfaces, a top edge, bottom edge, and right and left side edges. Right and left rails extend along the right and left edges, respectively, of the plate member. Opposing right and left slots extend longitudinally within the right and left rails. A stop ledge extends along the bottom edge of the plate member.

In another embodiment there is no plate member. The right and left rails are joined at their tops by a handle, at the bottom by the stop ledge, and by a cross-member located in a mid-portion thereof.

### BRIEF DESCRIPTION OF THE DRAWINGS

FIG. 1 is a front elevation view of a first embodiment of the display case of the present invention;

FIG. 2 is a cross sectional view of a first embodiment of the display case of the present invention, taken along line 2-2 of FIG. 1;

FIG. 3 is a bottom plan view, in cross-section, of a first embodiment of the display case of the present invention;

FIG. 4 is a front elevation view of a “Hot Wheels” type model car original packaging;

FIG. 5 is a side elevation view of a “Hot Wheels” type model car original packaging;

FIG. 6 is a front elevation view of the display case of the present invention showing a plurality of “Hot Wheels” type model car original packages displayed therein;

FIG. 7 is a side elevation view of two “Hot Wheels” type model car original packages shown in the position they would occupy when placed into the display case of the present invention;

FIG. 8 is a perspective view of a replacement package for holding model cars not contained in their original packaging that may be used with the display case of the present invention;

FIG. 9 is a side elevation view of a first embodiment of the display case of the present invention attached to a first type of stand;

FIG. 10 is a side elevation view of a first embodiment of the display case of the present invention attached to a second type of stand;

FIG. 11 is a front elevation view of a second embodiment of the display case of the present invention;

FIG. 12 is a cross sectional view of the second embodiment of the display case of the present invention, taken along line 12-12 of FIG. 11;

FIG. 13 is a front elevation view of a third embodiment of the display case of the present invention; and

FIG. 14 is front elevation view of a fourth embodiment of the display case of the present invention

### DESCRIPTION OF PREFERRED EMBODIMENTS

The display case 10 of a first embodiment of the present invention includes an elongated plate member 12 having inner and outer planar surfaces 14 and 15, respectively, a handle 16 located at its upper end, a bottom edge 17, and right and left side edges 18 and 19, respectively.

Substantially parallel right and left rails 20 and 22 are integral with, or attached to, right and left side edges 18 and 19, respectively, of plate member 12. Right and left rails 20 and 22 contain opposing slots 21 and 23, respectively. Preferably, plate member 12 and rails 20 and 22 are made of a transparent plastic.

A stop ledge member 26 extends between the lower ends of right and left rails 20 and 22, adjacent bottom edge 17 of plate 12. Stop ledge member 26 contains a slot 27, which has substantially the same depth as slots 21 and 23 of right and left rails 20 and 22. Stop ledge member 26 is attached to right and left rails 20 and 22 and to plate 12, such as by welding.

A hole and slot 28, and a hole 29, are adapted to receive wall fasteners and extend through plate 12 adjacent its top edge 16 and bottom edge 17, respectively. Hole and slot 28, and hole 29, are preferably beveled to allow the head of the fastener to be recessed flush with the outer planar surface 15 of plate 12.

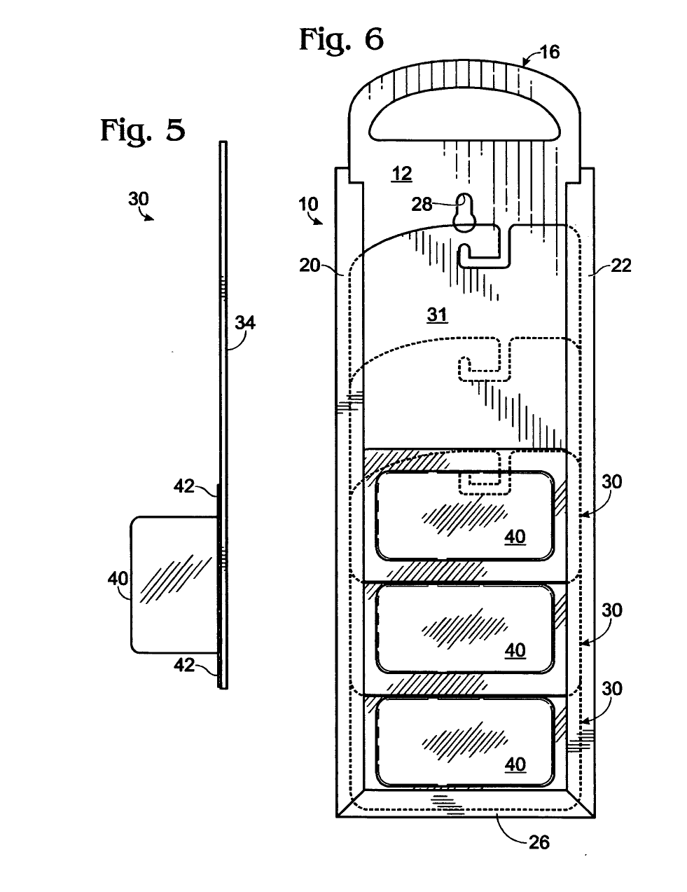

FIGS. 4 and 5 illustrate a conventional “Hot Wheels” type package 30. Package 30 does not, per se, form a part of the present invention. Package 30 includes a cardboard backing 31 having right and left side edges 32 and 34, respectively, bottom edge 36, and top edge 38. An opening 39 is cut into the top edge 38 to allow package 30 to be hung on a retail store display rack.

A transparent plastic box 40 has a skirt 42 that is removably attached to backing 32 adjacent its bottom edge 36. Transparent plastic box 40 contains a model car, not shown.

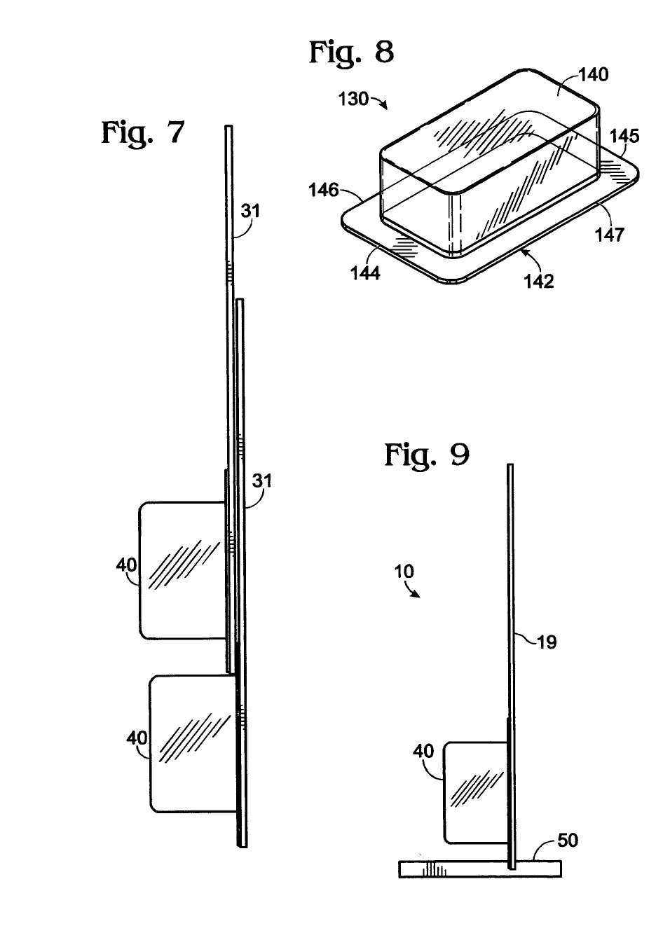

The distance between the interior base walls of slots 21 and 23 is substantially the same as the width of the cardboard backing 31 of package 30, i.e., the distance between right and left side edges 32 and 34 of package 30. This allows the side edges 32 and 34 of a first package 30 to be inserted into slots 21 and 23 and slid downwardly until the bottom edge 36 thereof comes into abutment with the bottom of slot 27 of stop ledge member 26. A second package 30 can likewise be inserted into slots 21 and 23 and slid downwardly until its bottom edge 36 comes into abutment with the upper surface of clear plastic box 40 of the first package 30. FIG. 7 shows the position two packages 30 would occupy when so inserted into slots 21 and 23, display case 10 being omitted from the drawing for sake of clarity. Additional packages 30 may be inserted into slots 21 and 23 until no more can be added. The gap between the outer planar surface 15 and the underside of the horizontal portion of rails 20 and 22, which gap forms slots 21 and 23, is selected to accommodate the total thickness of backings 31 for the number of packages 30 to be displayed. FIG. 6 illustrates a display case 10 made of transparent plastic containing three packages 30.

In the event a collector has removed his model cars from their original packaging and wishes to display them in display case 10, or has non-“Hot Wheels” type model cars, a replacement package or “garage” 130 can be used to replace the original packaging. As shown in FIG. 8, replacement package 130 has a transparent plastic box 140 adapted to receive a model car, not shown, in the same manner as with box 40 of original package 30. A backing 142 is adapted to be removably attached to the backside opening of transparent plastic box 140, such as by snap fitting or hinge means. Backing 142 has the same width (the distance between right and left sides 144 and 145) as original package 30, but its height (the distance between top and bottom edges 146 and 147) can be substantially the same as, or only slightly greater than, the corresponding height of plastic box 140.

Herein whenever the word “package” is used, it is intended to include both original package 30 and replacement package 130, and whenever the work “backing” is used it is intended to include both cardboard backing 31 of package 30 and backing 142 of replacement package 130.

Display case 10 can be made from plastic, wood, metal, etc. It is preferred to make display case 10 from plastic, and most preferably from a transparent plastic. Where display case 10 is made from plastic, it can be extruded with plate member 12, and right and left side rails 18 and 19 being integral i.e., a single piece.

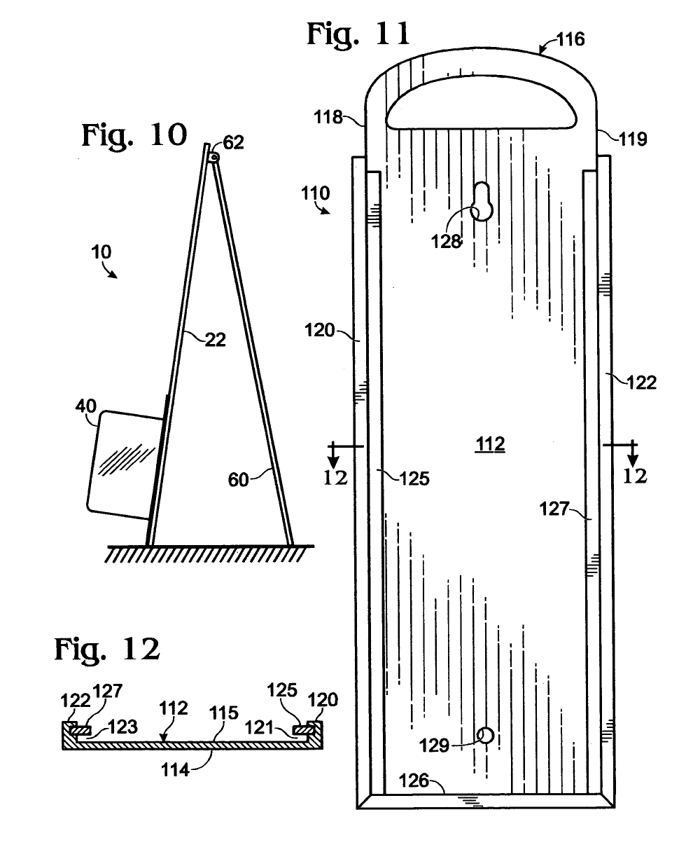

While a preferred form of the display case 10 is intended for mounting on a wall, table top or floor displays may be made by attaching a suitable stand member. FIG. 9 shows a stand 50 attached to the base of display case 10. FIG. 10 shows a stand member 60 attached to the back of the upper portion of display case 10 by a suitable hinge member 62. Stand member 60 is of the type used with picture frames.

FIGS. 11 and 12 show a display stand 110 which is an alternative embodiment of display case 10. The display case 110 of the present invention includes an elongated plate member 112 having inner and outer planar surfaces 114 and 115, respectively, a handle 116 located along its upper portion, and right and left side edges 118 and 119, respectively.

Right and left rails 120 and 122 extend outwardly from the outer planar surface 115 of plate 112 along the right and left side edges 118 and 119 thereof, respectively. Right and left rails 120 and 122 contain opposing recesses into which opposing right and left flexible strips 125 and 127, respectively, are press fit. The space between the outer planar surface 115 of plate 112 and the inner exposed surfaces of flexible strips 125 and 127 form right and left slots 121 and 123, respectively.

A stop ledge 126 extends outwardly from the outer planar surface 115 of plate 112 across its bottom edge 117. The height of stop ledge 126 above planar surface 115 is substantially the same as the height of right and left rails 120 and 122 above planar surface 115.

A hole and slot 128 and hole 129 for receiving wall fasteners extend through plate 112 adjacent its top and bottom edges 116 and 117. Hole and slot 128 and hole 129 are preferably beveled to allow the head of the fastener to be recessed flush with the outer planar surface 115 of plate 112.

“Hot Wheels” type packages 30 can be inserted into display case 110 in the same manner as with display case 10, or they can be inserted by pressing the edges 32 and 34 of a package 30 against flexible strips 125 and 127 one at a time to thereby cause flexible strips 125 and 127 to bend inwardly and permit edges 32 and 34 to be inserted into slots 121 and 123.

Display case 110 can be attached to stand members 50 or 60, as discussed above relative to display case 10.

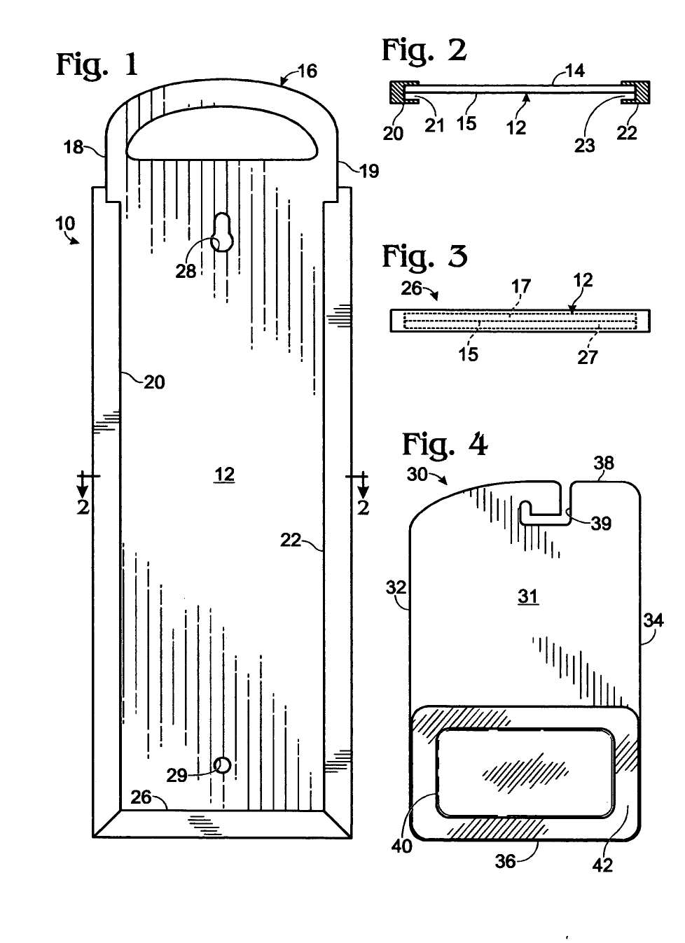

FIG. 13 shows a third alternative embodiment of the invention. In this embodiment, wherein elements identical to those shown in FIG. 1 have the same reference numbers but increased by 200, the handle 216 and right and left rails 220 and 222 are formed as an integral unit, and the elongated plate member (shown as 12 in FIG. 1) has been omitted. Stop ledge member 226 is attached to the lower ends of right and left rails 220 and 222, and a strengthening cross member 202 extends between rails 220,222 at a mid-portion thereof and is attached thereto. Right and left rail members 220 and 222 can have the construction of either the embodiment shown in FIG. 1 or the embodiment shown in FIG. 11.

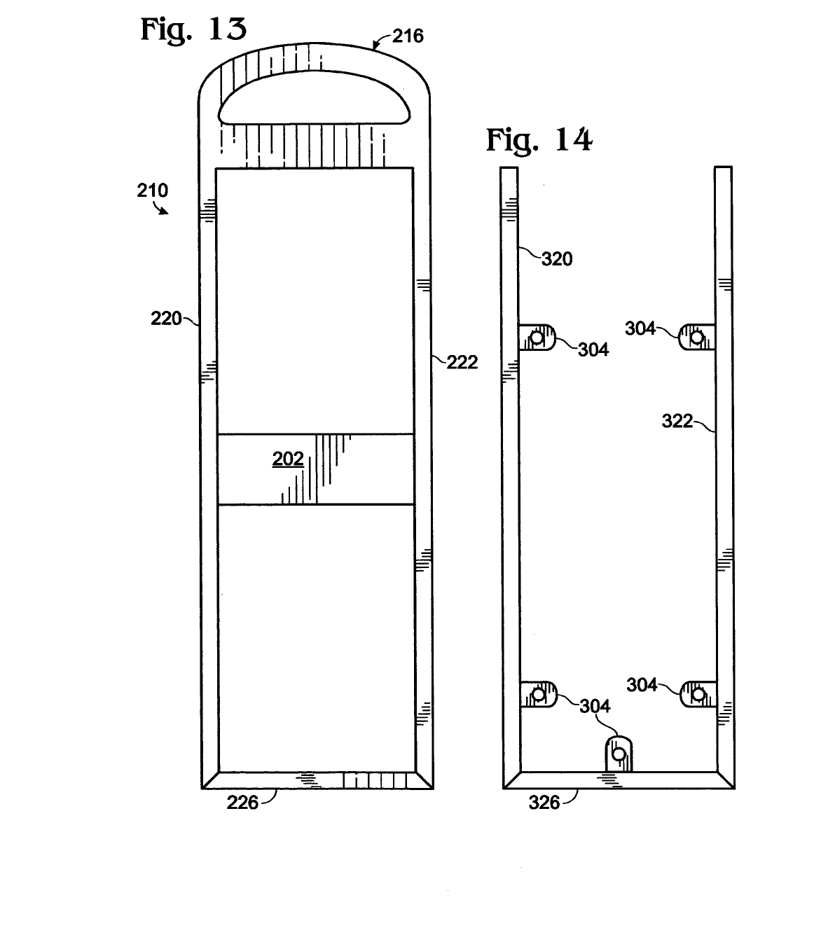

FIG. 14 shows a fourth alternative embodiment of the invention. In this embodiment, wherein elements identical to those shown in FIG. 1 have the same reference numbers but increased by 300, only right and left side rails 320 and 322 and stop ledge member 326 are present. The rails 320, 322 and stop ledge member 326 are attached to a wall by fasteners extending through fastener receiving tabs 304. Right and left rail members 320 and 322 can have the construction of either the embodiment shown in FIG. 1 or the embodiment shown in FIG. 11.

Handles 16, 116 and 216 can either be permanently attached to the rest of the display case or may be removable.

It will be obvious to those having skill in the art that many changes may be made to the details of the above-described embodiments of this invention without departing from the underlying principles thereof. The scope of the present invention should, therefore, be determined only by the following claims.

The invention claimed is:

1. A case for displaying model cars contained in a package, said package including a backing having right and left side edges and a transparent box attached to said backing for housing a model car, said case comprising:
substantially parallel right and left rails having upper and lower ends and opposing right and left slots, respectively, said right and left slots extending substantially the entire length of said right and left rails, said right and left slots being spaced apart a distance adapted to receive the right and left side edges of said backing therein, said right and left rails having a length adapted to receive two or more of said packages;
a stop ledge extending between the lower ends of said right and left rails; and
means for holding said case.

2. The display case of claim 1 including a cross member extending between mid-portions of said right and left rails.

3. The display case of claim 2 including a handle attached to the upper ends of said rails.

4. The display case of claim 1 wherein said means for holding said case is a stand adapted for table top or floor display.

5. The display case of claim 1 wherein said means for holding said case are means for attaching said case to a wall.

6. A case for displaying model cars contained in a package, said package including a backing having right and left side edges and a transparent box attached to said backing for housing a model car, said case comprising:
a plate having inner and outer planar surfaces, a top edge, bottom edge, and right and left side edges;
right and left rails extending along the right and left edges, respectively, of said plate;
opposing right and left slot forming retention members extending longitudinally within or from said right and left rails, respectively, said right and left slots extending substantially the entire length of said right and left rails, said right and left slots being spaced apart a distance adapted to receive the right and left side edges of said backing therein, said right and left rails having a length adapted to receive two or more of said packages; and
a stop ledge extending along said bottom edge of said plate.

7. The display case of claim 6 including a handle extending from the top edge of said plate.

8. The display case of claim 7 wherein said handle is removable.

9. The display case of claim 6 wherein said right and left slot forming retention members are flexible strips inserted into said right and left rails.

10. A model car display comprising:
(a) a display case including:
a plate having inner and outer planar surfaces, a top edge, bottom edge, and right and left side edges;
right and left rails extending along the right and left edges, respectively, of said plate, and extending outwardly from said outer planar surface of said plate;
opposing right and left slot forming retention members extending longitudinally within or from said right and left rails, respectively, each said slot having an interior base wall; and
a stop ledge extending along said bottom edge of said plate; and
(b) a plurality of model cars, each model car being contained within a package, each said package including:
a transparent box for holding a model car, said transparent box having a top edge, a bottom edge, and side edges, and a backing to which said transparent box is attached, said backing having a top edge, a bottom edge, and side edges, the distance between said side edges of said backing being substantially equal to the distance between said interior base walls of said slots of said display case;
the lowest said package having the bottom edge of its backing in abutment with said stop ledge, and each of said remaining packages having the bottom edge of its backing in abutment with the transparent box of the adjacently lower of said packages to thereby form a vertical array of said packages.

11. The display case of claim 10 including a handle attached to the top edge of said plate.

12. The display case of claim 11 wherein said handle is removable.

13. The display case of claim 10 wherein said packaging is the packaging in which the model car was sold to the purchaser.

14. The display case of claim 10 wherein said packaging is a replacement for the original packaging in which the model car was sold to the purchaser, and the distance between said top and bottom edges of said backing is substantially the same as or only slightly greater than the distance between said top and bottom edges of said transparent box.
